(19) United States
(12) Patent Application Publication
(10) Pub. No.: US 2022/0380581 A1
(43) Pub. Date: Dec. 1, 2022

(54) RUBBER COMPOSITION AND PRODUCTION METHOD THEREFOR

(71) Applicant: TSOH CORPORATION, Shunan-shi, Yamaguchi (JP)

(72) Inventors: Toshihiro SAITO, Yokkaichi-shi, Mie (JP); Naoyuki ISHIDA, Yokkaichi-shi, Mie (JP)

(73) Assignee: TSOH CORPORATION, Shunan-shi, Yamaguchi (JP)

(21) Appl. No.: 17/773,705

(22) PCT Filed: Nov. 12, 2020
(86) PCT No.: PCT/JP2020/042284

§ 371 Date: May 2, 2022

(30) Foreign Application Priority Data
Nov. 19, 2019 (JP) 2019-2097

(51) Int. Cl. C08L 11/00; C08J 3/20

(52) U.S. Cl. CPC C08L 11/00; C08J 3/203; C08L 2205/16; C08J 2311/00; C08J 2401/02

(57) ABSTRACT

To provide a rubber composition excellent in elasticity and low loss property.

A rubber composition comprising 100 parts by weight of a chloroprene rubber and from 1.2 to 3.0 parts by weight of cellulose nanofibers, characterized in that a vulcanized sheet obtained by vulcanizing the rubber composition has a 100% tensile stress (M100) increased by 1.5 MPa or more per part by weight of the cellulose nanofibers added,
where the increase of M100 is calculated by subtracting M100 of a vulcanized sheet containing no cellulose nanofibers from M100 of the vulcanized sheet containing the cellulose nanofibers, and dividing the difference by the amount of the cellulose nanofibers contained.

### TECHNICAL FIELD

The present invention relates to a rubber composition and a method for producing it.

### BACKGROUND ART

Chloroprene rubbers are widely used for various applications due to good balance of physical properties, among various synthetic rubbers. Depending upon modification at their terminals, general-purpose mercaptan modified chloroprene rubbers, sulfur-modified chloroprene rubbers excellent in dynamic characteristics, etc., may be mentioned, and the latter are more excellent in mechanical properties. Due to demands for higher performance and intensified usage environment in recent years, higher elasticity and improvement in heat resistance have been desired.

As the index to elasticity, tensile stress may be mentioned, which can be improved usually by incorporating a reinforcing material such as carbon black or silica, however, reinforcing effects of such particulate reinforcing material are limited depending upon the particle size and the specific surface area. Further, reinforcement by incorporating a reinforcing material remarkably hardens a vulcanized rubber simultaneously and thereby lowers processability into rubber products. Accordingly, reinforcing effects are limited to maintain appropriate rubber hardness.

On the other hand, a fibrous reinforcing material has been proposed, and e.g. tires having cellulose incorporated have been proposed (for example, Patent Document 1). However, hydrophobic cellulose is inferior in dispersibility in hydrophobic rubber, and thereby has a low reinforcing effect. To solve this, tires having nano-order cellulose nanofibers and a dispersing agent to disperse the nanofibers or a silane coupling agent to fix the nanofibers incorporated in natural rubber latex have been proposed (for example, Patent Documents 2 and 3). However, for such method, a chemical to disperse a rubber and the cellulose nanofibers, such as a dispersing agent, is further necessary, thus increasing the cost. Further, studies on the chloroprene rubber have not been extensively conducted practically.

On the other hand, it is known that a chloroprene polymer is obtained by polymerizing chloroprene in the presence of an emulsifier in an aqueous emulsion containing the emulsifier and an initiator. In general, this polymerization reaction is carried out in the presence of an alkali metal salt of a carboxylic acid in a strongly alkaline atmosphere, however, since cellulose is hydrolyzed under strongly alkaline conditions, studies on strongly alkaline chloroprene latex have not been extensively conducted practically.

### PRIOR ART DOCUMENTS

### Patent Documents

Patent Document 1: JP-A-2006-206864

Patent Document 2: JP-A-2009-191197

Patent document 3: JP-A-2009-191198

### DISCLOSURE OF INVENTION

### Technical Problem

The present invention has been made to overcome such problems, and the object of the present invention is to provide a chloroprene rubber composition by which low distortion and excellent tensile stress are achieved, and a method for producing it.

### Solution to Problem

Under these circumstances, the present inventors have conducted extensive studies to achieve the above object and as a result, found that by using a rubber composition containing a chloroprene rubber and cellulose nanofibers, excellent tensile stress with low distortion, despite of low hardness, are achieved.

That is, embodiments of the present invention are the following [1] to [5]

[1] A rubber composition comprising 100 parts by weight of a chloroprene rubber and from 1.2 to 3.0 parts by weight of cellulose nanofibers, characterized in that a vulcanized sheet obtained by vulcanizing the rubber composition has a 100% tensile stress (M100) increased by 1.5 MPa or more per part by weight of the cellulose nanofibers added.

The increase of M100 is calculated by subtracting M100 of a vulcanized sheet containing no cellulose nanofibers from M100 of the vulcanized sheet containing the cellulose nanofibers, and dividing the difference by the amount of the cellulose nanofibers contained.

[2] The rubber composition according to [1], wherein the cellulose nanofibers are such that the 1 wt % aqueous solution has a surface tension of 60 mN/m or lower.

[3] The rubber composition according to [1] or [2], wherein the cellulose nanofibers contain no carboxylate nor carboxylic acid, and are fibrillated only by mechanical treatment.

[4] A method for producing the rubber composition as defined in any one of [1] to [3], which comprises mixing an aqueous dispersion of cellulose nanofibers with a chloroprene rubber latex to obtain a cellulose nanofibers dispersed rubber latex mixture, and freeze-coagulating the chloroprene rubber, washing it with water and drying it.

[5] The method for producing the rubber composition according to [4], wherein the cellulose nanofibers dispersed rubber latex mixture has a viscosity of 1,000 mPa·s or lower.

### ADVANTAGEOUS EFFECTS OF INVENTION

By using the rubber composition of the present invention, a vulcanized rubber which is less distorted and which has excellent tensile stress can be obtained.

### DESCRIPTION OF EMBODIMENTS

Now, the present invention will be described in detail below.

According to one embodiment of the present invention, the rubber composition contains 100 parts by weight of a chloroprene rubber and from 1.2 to 3.0 parts by weight of cellulose nanofibers, and a vulcanized sheet obtained by vulcanizing the rubber composition has a 100% tensile stress (M100) increased by 1.5 MPa or more per part by weight of the cellulose nanofibers added.

The chloroprene rubber may be obtained by emulsion-polymerizing chloroprene, or chloroprene and a monomer copolymerizable therewith.

The monomer copolymerizable with chloroprene may, for example, be 2,3-dichloro-1,3-butadiene, 2-cyano-1,3-butadiene, 1-chloro-1,3-butadiene, 1,3-butadiene, styrene, acrylonitrile, methyl methacrylate, methacrylic acid or acrylic acid. One or more of them may be used in combination with chloroprene but is not necessarily used, and is properly used depending upon physical properties required. The amount of the copolymerizable monomer is not particularly limited, and is usually 30 parts by weight or less per 100 parts by weight of the chloroprene rubber so as not to impair the properties of the chloroprene rubber.

The chloroprene rubber preferably contains from 3 to 7 wt % of either one or both of a carboxylic acid and an alkali metal salt of a carboxylic cid. Within such a range, emulsification stability at the time of polymerizing chloroprene will be excellent, and further, drawbacks such as imperfect freezing will not occur when the rubber is taken out from the latex by freeze drying.

The carboxylic acid or the alkali metal salt of a carboxylic acid may, for example, be a resin acid or its alkali metal salt, a fatty acid or its alkali metal salt, or a polycarboxylic acid or its alkali metal salt. The alkali metal salt may, for example, be lithium, sodium, potassium or cesium. They may be used alone or in combination of two or more, and in view of polymerization stability, agglomeration property at the time of drying, and rubber performance, an alkali metal salt of a resin acid, particularly potassium salt of a resin acid is preferably used.

Emulsion polymerization for a chloroprene rubber may be conducted, for example, by a method of mixing the above monomer with an emulsifier, water, a polymerization initiator, a chain transfer agent and other stabilizer, etc., conducting polymerization at a predetermined temperature, and adding a polymerization terminator at a point where a predetermined degree of polymerization conversion is achieved to terminate the polymerization.

As the emulsifier, the above alkali metal salt of the carboxylic acid may be used.

The amount of the emulsifier is not particularly limited, and considering stability of the chloroprene latex obtained after the polymerization, it is preferably from 3 to 7 parts by weight per 100 parts by weight of the chloroprene rubber.

As the polymerization initiator, a known free radical substance, for example, an inorganic or organic peroxide such as a peroxide such as potassium sulfate or ammonium persulfate, hydrogen peroxide or tert-butyl hydroperoxide may be used.

They may be used alone or may be used as a redox system in combination with a reducing substance such as a thiosulfate, a thiosulfite, a hydrosulfite or an organic amine.

The polymerization temperature is not particularly limited, and is preferably within a range of from 10 to 50° C.

In the method for producing the rubber composition according to one embodiment of the present invention, the polymerization completion timing is not particularly limited, and in view of productivity, it is common to conduct polymerization to a degree of conversion of the monomer of 60% or higher and up to 95%. If the degree of conversion is lower than 60%, the amount of production tends to be small and the solid content of the latex tends to be low, and the cost for dying water tends to be high, and if it is 95% or higher, the polymerization time will be very long.

The polymerization terminator is not particularly limited so long as it is a terminator commonly used, and may, for example, be phenothiazine, 2,6-t-butyl-4-methylphenol or hydroxylamine.

The Mooney viscosity of the raw material rubber is not particularly limited so long as the high elastic stress of the present invention is satisfied, and considering kneading workability, it is preferably from 20 to 80. To measure the Mooney viscosity, measurement is started 1 minute after start of preheating at an angular speed of 2 revolutions per minute at a temperature of 100° C., and a value 4 minutes after the start of the measurement is read.

The cellulose nanofibers are one obtained by fibrillating fibers of cellulose contained in wood to the average fiber size of from several nanometer to several tens nanometer level. The cellulose fibrillating treatment may be one mainly by mechanical treatment or one by chemical treatment of imparting functional groups in combination with mechanical treatment to fibrillate the fibers into thinner single nano level nanofibers while agglomeration of the cellulose nanofibers is suppressed.

In the present invention, it is preferred to use cellulose nanofibers such that the 1 wt % aqueous solution of the cellulose nanofibers has a surface tension of 60 mN/m or lower. Such cellulose nanofibers may be cellulose nanofibers obtained by fibrillation only by mechanical treatment without chemical treatment, having amphiphilicity. By the cellulose nanofibers not chemically treated and having no carboxylate nor carboxylic acid, the state of dispersion of the cellulose nanofibers in the rubber tends to be favorable, the tensile stress of the obtainable vulcanized rubber will improve, and favorable handling efficiency will be obtained. Accordingly, it is preferred to use cellulose nanofibers containing no carboxylate nor carboxylic acid. Amphiphilicity means the cellulose nanofibers having both hydrophilic moiety with high affinity with water and hydrophobic moiety with low affinity with water, and as disclosed in e.g. Japanese Patent No. 5419120, it may be achieved by subjecting the aqueous suspension sample to counter collision at high speed. By the cellulose nanofibers having amphiphilicity, affinity of the cellulose nanofibers for the hydrophobic rubber tends to be high, and a remarkable improvement of the tensile stress will be obtained with a smaller amount mixed. Usually, pure water has a surface tension of about 72 mN/m, and the surface tension decreases as the hydrophobicity increases. When the aqueous solution of the cellulose nanofibers has a surface tension of 60 mN/m or lower at 1 wt % concentration, the cellulose nanofibers have amphiphilicity and have high affinity for rubber.

In the rubber composition according to one embodiment of the present invention, the content of the cellulose nanofibers is, per 100 parts by weight of the chloroprene rubber, from 1.2 to 3.0 parts by weight, preferably from 1.5 to 2.5 parts by weight. When the cellulose nanofibers content is 1.2 parts by weight or higher, a high tensile stress relative to the hardness will be obtained. Further, when the cellulose nanofibers content is 3.0 parts by weight or lower, handling efficiency at the time of mixing the cellulose nanofibers will be favorable.

The rubber composition may be obtained by mixing an aqueous dispersion of the cellulose nanofibers with a chloroprene rubber latex to prepare a cellulose nanofibers dispersed rubber latex mixture, and removing water from the mixture.

The chloroprene rubber latex is one having the chloroprene rubber emulsified and dispersed by the alkali metal salt of a carboxylic acid, and its production method is not particularly limited. A reaction liquid having chloroprene monomer, or chloroprene monomer and a monomer copolymerizable with chloroprene, emulsion-polymerized, or a liquid having the chloroprene rubber dissolved in a solvent and emulsified and dispersed by the alkali metal salt of a carboxylic acid may be used.

The aqueous dispersion of the cellulose nanofibers is obtained by fibrillating wood, pulp or the like to have predetermined fiber size and fiber length by mechanical treatment.

The rubber composition may be obtained by mixing the aqueous dispersion of the cellulose nanofibers with the chloroprene rubber latex to obtain a cellulose nanofibers dispersed rubber latex mixture, removing water from the mixture, and washing the chloroprene rubber with water and drying it.

The method of mixing the chloroprene rubber latex and the aqueous dispersion of the cellulose nanofibers is not particularly limited, and the mixture may be obtained by mixing the chloroprene latex and the aqueous dispersion of the cellulose nanofibers by a propeller stirrer, a homomixer, a high pressure homogenizer or the like, until the mixture becomes uniform (no aggregates or the like observed) in appearance.

As a method of removing water from the cellulose nanofibers dispersed rubber latex mixture (drying method), heat drying, agglomeration with an acid or a salt, or freeze drying may be mentioned. The emulsifier, the coagulated liquid and moisture may remain in the interior of the rubber, thus inhibiting drying. Accordingly, the most effective and easy method is freeze drying such that the rubber is precipitated by freezing (freeze-coagulated), the extra emulsifier and the like are removed by washing with water, and then the rubber is hot air dried. Further, it is more preferred to conduct freezing drying at a pH of the cellulose nanofibers dispersed rubber latex mixture of 10 or lower, so that the rubber will readily be precipitated.

In the method of freeze-coagulating the rubber from the cellulose nanofibers dispersed rubber latex mixture and drying, the viscosity of the cellulose nanofibers dispersed rubber latex mixture is preferably 1,000 mPa·s or lower, more preferably 600 mPa·s or lower. If the viscosity is higher than 1,000 mPa·s, adaptability to existing production equipment will remarkably be deteriorated, and the rubber composition will hardly be obtained.

The obtained cellulose nanofibers-containing the rubber composition may be blended with various compounding agents and kneaded, and heated in the same manner as a conventional chloroprene rubber, to form a vulcanized rubber.

The obtained vulcanized rubber is less distorted and has excellent tensile stress, and has a remarkably improved 100% tensile stress relative to the amount of the cellulose nanofibers added. Particularly when the 100% tensile stress is improved by 1.5 MPa or more per part by weight of the cellulose nanofibers added, the 100% tensile stress can be increased while the hardness is suppressed.

The increase of the 100% tensile stress (M100) of a vulcanized sheet obtained by vulcanizing the rubber composition is calculated by subtracting M100 of a vulcanized sheet containing no cellulose fibers from M100 of the vulcanized sheet containing the cellulose nanofibers, and dividing the difference by the amount of the cellulose nanofibers contained, to obtain an increase of M100 per part by weight of the cellulose nanofibers.

### EXAMPLES

Now, the present invention will be described in further detail with reference to Examples. However, it should be understood that the present invention is by no means restricted thereto.

### Preparation of Mercaptan-Modified Chloroprene Rubber Latex

100 Parts by weight of chloroprene as a monomer mixture, and an aqueous solution for emulsification containing 3.5 parts by weight of potassium resinate, 0.7 parts by weight of a sodium salt of a condensate of naphthalene sulfonate and formaldehyde, 0.25 parts by weight of sodium hydroxide, 0.2 parts by weight of n-dodecylmercaptan and 90 parts by weight of water, were mixed and stirred for emulsification, and to the resulting emulsion, a polymerization catalyst comprising 0.04 parts by weight of potassium persulfate and 5 parts by weight of water was added at a constant rate by a pump to conduct polymerization. The polymerization was conducted by adding the polymerization catalyst up to the degree of polymerization conversion of 70%, and a polymerization terminator comprising 0.01 parts by weight of t-butylcatechol, 0.02 parts by weight of sodium dodecylbenzenesulfonate, 0.5 parts by weight of chloroprene and 0.5 parts by weight of water was added to terminate the polymerization. Unreacted chloroprene was removed and recovered by steam stripping under reduced pressure to obtain a mercaptan-modified chloroprene rubber latex.

### Preparation of Cellulose Nanofibers-Containing Rubber Composition

To the chloroprene rubber latex, a predetermined amount of an aqueous dispersion of cellulose nanofibers was added and mixed by an autohomomixer (manufactured by PRIMIX Corporation, PRIMIX) at 2,000 rpm for 10 minutes to prepare a cellulose nanofibers dispersed rubber latex mixture. Then, the mixture was adjusted to have a pH of 6.5 with 15 wt % diluted acetic acid, and freeze-coagulated to precipitate a polymer, which was washed with water and hot air dried.

### Measurement of Surface Tension

The surface tension of the aqueous dispersion of the cellulose nanofibers was measured by a surface tension meter (manufactured by Kyowa Interface Scientific Co., Ltd., DY-300).

### Measurement of Viscosity

The viscosity of the cellulose nanofibers dispersion was measured by vismetron viscometer (manufactured by SHIBAURA SEMTEK CO., LTD., VD2).

### Measurement of Cellulose Nanofibers Content

The cellulose nanofibers-containing rubber composition was dissolved in chloroform in an amount 200 times the amount of the composition for 24 hours to remove the chloroprene rubber. The solution was subjected to filtration through a 100 mesh metal screen and hot air dried in an oven at 100° C. to obtain cellulose nanofibers. The weight was measured to calculate the amount of the cellulose nanofibers contained in the chloroprene rubber composition.

### Preparation of Rubber Compound

Per 100 parts by weight of the chloroprene rubber component in the cellulose nanofibers-containing chloroprene rubber composition, 40 parts by weight of carbon black (manufactured by TOKAI CARBON, SEAST SO), 4 parts by weight of magnesium oxide (manufactured by Kyowa Chemical Industry, Co., Ltd, Kyowamag 150), 0.5 parts by weight of stearic acid (manufactured by NOF CORPORATION, beads stearic acid Tsubaki), 1 part by weight of an age resistor (manufactured by OUCHI SHINKO CHEMICAL INDSUTRIAL CO., LTD., SUNNOC), 15 parts by weight of a plasticizer (manufactured by JAPAN SUN OIL COMPANY LTD, SUNTHENE 415), 5 parts by weight of zinc oxide (manufactured by Sakai Chemical Industry Co., Ltd., Grade No. 2 (JIS)) and 1 part by weight of ethylene thiourea (manufactured by SANSHIN CHEMICAL INDUSTRY CO., LTD., SANCELER 22-C) were added by an open roll kneading machine to obtain a cellulose nanofibers-containing chloroprene rubber compound.

### Preparation of Vulcanized Product

The obtained rubber compound was press-vulcanized at 160° C. for 15 minutes to prepare a vulcanized sheet.

### Measurement of Hardness of Vulcanized Product

The hardness of the obtained vulcanized sheet was evaluated in accordance with JIS K6253 (2012). As the durometer, type A was selected.

### Measurement of Pphysical Properties of Vulcanized Product

The 100% tensile stress (M100) of the obtained vulcanized sheet was evaluated in accordance with JIS K6251 (2012) at a pulling rate of 500 mm/min at 23° C.

### Example 1

As the cellulose nanofibers, Nanoforest S manufactured by Chuetsu Pulp & Paper Co., Ltd. was mixed with the chloroprene rubber latex so that the amount of the cellulose nanofibers is 2.0 parts by weight per 100 parts by weight of the chloroprene rubber as calculated as solid, and stirred by the above method for 10 minutes to obtain a cellulose nanofibers-containing rubber latex dispersion. The dispersion had a viscosity of 540 mPa·s and had no problem in handling, and a rubber composition was obtained by freeze drying. Nanoforest S is amphipathic cellulose nanofibers produced by mechanical fibrillation means, and the aqueous dispersion of the cellulose nanofibers had a surface tension of 55 mN/m at a concentration of 1 wt %.

From this rubber composition, a vulcanized product was prepared in accordance with the above method, and its hardness and 100% tensile stress (M100) were measured. The results are shown in Table 1. It is found from Table 1 that the hardness was 73, M100 was 7.3 MPa and thus the increase of M100 was 3.8 MPa, and from the content of the cellulose nanofibers of 2.0 parts by weight, the increase of M100 per part by weight of the cellulose nanofibers was 1.9 MPa per part by weight, and M100 relative to the hardness was high, such being favorable.

### Example 2

A cellulose nanofibers-containing rubber latex dispersion was obtained in the same manner as in Example 1 except that the amount of the cellulose nanofibers mixed was 2.8 parts by weight per 100 parts by weight of the chloroprene rubber as calculated as solid. The dispersion had a viscosity of 870 mPa·s and had no problem in handling, and a rubber composition was obtained by freeze drying. From this rubber composition, a vulcanized product was prepared, and its hardness and M100 were measured. The increase of M100 per part by weight of the cellulose nanofibers, obtained in the same manner as in Example 1, was 1.9 MPa per part by weight, and M100 relative to the hardness was high, such being favorable.

### Example 3

A cellulose nanofibers-containing rubber latex dispersion was obtained in the same manner as in Example 1 except that the amount of the cellulose nanofibers mixed was 1.5 parts by weight per 100 parts by weight of the chloroprene rubber as calculated as solid. The dispersion had a viscosity of 340 mPa·s and had no problem in handling, and a rubber composition was obtained by freeze drying. From this rubber composition, a vulcanized product was prepared, and its hardness and M100 were measured. The increase of M100 per part by weight of the cellulose nanofibers, obtained in the same manner as in Example 1, was 1.8 MPa per part by weight, and thus M100 relative to the hardness was high, such being favorable.

### Comparative Example 1

A rubber composition and a vulcanized product were prepared in the same manner as in Example 1 except that no cellulose nanofibers were mixed, and the hardness and M100 were measured. Both hardness and M100 were low.

### Comparative Example 2

A cellulose nanofibers-containing rubber latex dispersion was obtained in the same manner as in Example 1 except that the amount of the cellulose nanofibers mixed was 0.9 parts by weight per 100 parts by weight of the chloroprene rubber as calculated as solid. The dispersion had a viscosity of 210 mPa·s and had no problem in handling, and a rubber composition was obtained by freeze drying. From this rubber composition, a vulcanized product was prepared, and its hardness and M100 were measured. Both the increase of M100 per part by weight of the cellulose nanofibers, and M100 relative to the hardness, were low.

### Comparative Example 3

A cellulose nanofibers-containing rubber latex dispersion was obtained in the same manner as in Example 1 except that the amount of the cellulose nanofibers mixed was 3.5 parts by weight per 100 parts by weight of the chloroprene rubber as calculated as solid, however, the dispersion had a viscosity of 1,210 mPa·s and was inferior in handling efficiency, and thus no rubber composition could be obtained.

### Comparative Example 4

A cellulose nanofibers-containing rubber latex dispersion was obtained in the same manner as in Example 1 except that the cellulose nanofibers used were KY-100G manufactured by Daicel FineChem Ltd. KY-100G was hydrophilic cellulose nanofibers produced by mechanical fibrillation means, and the aqueous dispersion of the cellulose nanofibers had a surface tension of 70 mN/m at a concentration of 1 wt %. The dispersion had a viscosity of 390 mPa·s and had no problem in handling, and a rubber composition was obtained by freeze drying. From this rubber composition, a vulcanized product was prepared, and its hardness and M100 were measured. Both the increase of M100 per part by weight of the cellulose nanofibers, and M100 relative to the hardness, were low.

TABLE 1

| | | | | Comp. | Comp. | Comp. | Comp. |
|---|---|---|---|---|---|---|---|
| | Ex. 1 | Ex. 2 | Ex. 3 | Ex. 1 | Ex. 2 | Ex. 3 | Ex. 4 |
| Compounding ratio | | | | | | | |
| Chloroprene rubber | 100 | 100 | 100 | 100 | 100 | 100 | 100 |
| (parts by weight) | | | | | | | |
| Cellulose nanofibers | 2.0 | 2.8 | 1.5 | — | 0.9 | 3.5 | 2.0 |
| (parts by weight) | | | | | | | |
| Properties of dispersion | | | | | | | |
| Viscosity (mPa · s) | 540 | 870 | 340 | 30 | 210 | 1210 | 390 |
| Handling efficiency | ∘ | ∘ | ∘ | ∘ | ∘ | x | ∘ |
| Normal state properties | | | | | | | |
| Hardness | 73 | 75 | 72 | 67 | 70 | — | 73 |
| 100% tensile stress (MPa) | 7.3 | 8.8 | 6.3 | 3.6 | 4.7 | — | 5.8 |
| Increase of tensile stress | 1.9 | 1.9 | 1.8 | — | 1.2 | — | 1.1 |
| (MPa per part by weight) | | | | | | | |

The present invention has been described in detail with reference to specific embodiments. However, it is apparent to those skilled in the art that various changes and modifications are possible without departing from the concept and the range of the present invention.

The entire disclosure of Japanese Patent Application No. 2019-209097 filed on Nov. 19, 2019 including specification, claims, drawings and summary is incorporated herein by reference in its entirety.

1. A rubber composition comprising 100 parts by weight of a chloroprene rubber and from 1.2 to 3.0 parts by weight of cellulose nanofibers, characterized in that a vulcanized sheet obtained by vulcanizing the rubber composition has a 100% tensile stress (M100) increased by 1.5 MPa or more per part by weight of the cellulose nanofibers added, where the increase of M100 is calculated by subtracting M100 of a vulcanized sheet containing no cellulose nanofibers from M100 of the vulcanized sheet containing the cellulose nanofibers, and dividing the difference by the amount of the cellulose nanofibers contained.

2. The rubber composition according to claim 1, wherein the cellulose nanofibers are such that the 1 wt % aqueous solution has a surface tension of 60 mN/m or lower.

3. The rubber composition according to claim 1, wherein the cellulose nanofibers contain no carboxylate nor carboxylic acid, and are fibrillated only by mechanical treatment.

4. A method for producing the rubber composition as defined in claim 1, which comprises mixing an aqueous dispersion of cellulose nanofibers with a chloroprene rubber latex to obtain a cellulose nanofibers dispersed rubber latex mixture, and freeze-coagulating the chloroprene rubber, washing it with water and drying it.

5. The method for producing the rubber composition according to claim 4, wherein the cellulose nanofibers dispersed rubber latex mixture has a viscosity of 1,000 mPa·s or lower.
